(19) United States
(12) Patent Application Publication
(10) Pub. No.: US 2025/0109611 A1
(43) Pub. Date: Apr. 3, 2025

(54) A LOCKING DEVICE

(71) Applicant: 9DESIGN.BE, Wilrijk (BE)

(72) Inventor: Roel Boutelegier, Wilrijk (BE)

(73) Assignee: 9DESIGN.BE, Wilrijk (DE)

(21) Appl. No.: 18/834,365

(22) PCT Filed: Feb. 7, 2023
(86) PCT No.: PCT/EP2023/052978

§ 371 Date: Jul. 30, 2024

(30) Foreign Application Priority Data
Feb. 7, 2022 (EP) 22155401.7

(51) Int. Cl. E05B 47/02; E05B 47/00; E05B 63/00; E05C 1/06

(52) U.S. Cl. CPC E05B 47/026; E05B 47/0012; E05B 63/0073; E05C 1/06; E05B 2047/0069

(57) ABSTRACT

A locking device is provided that includes a lock having a bolt; and a counter plate defining a slot for receiving the bolt and as such allowing locking an access point. The locking device also includes a housing; an electrically powered actuator driving the bolt or counter plate between a locking position wherein said bolt is positioned in the slot of the counter plate and an unlocking position. A carriage is movably mounted in the housing between an active position and an inactive position, such that in an inactive position of the carriage the bolt and counter plate cannot engage with one another. A spring is provided in the housing and biasing the carriage to its active carriage. A handle configured to drive the carriage by manpower against the force of the spring.

### FIELD OF THE INVENTION

The present invention concerns a locking device comprising an manually operable emergency opening system overruling an electrically driven locking and unlocking.

### BACKGROUND TO THE INVENTION

Locking devices with an emergency opening exist in various forms. FR2592911 for example discloses a locking device comprising a housing wherein an electrically driven actuator is provided for moving a bolt from a locking position to an unlocking position and vice versa. The actuator is hereby movably mounted in the housing between an active position wherein the bolt can effectively protrude from the housing to close door and an inactive position, wherein the bolt is retracted in the housing irrespective the position its position versus the actuator. The actuator is lodged between a removable pen and a spring, the spring biasing the actuator to the inactive position. In case of an emergency, the pen is to be removed, such that the spring forces the actuator in the inactive position.

Such known locking device has several drawbacks. Firstly, after removal of the pen, the lock remains in an inactive position until a manual intervention is done of recompressing the spring by moving the actuator in the active position and reinstatement of the pen holding the actuator in place. Hence, the door on which this known lock is provided remains open until a manual technical intervention. Secondly, the emergency opening mechanism may fail due to a blocking of the spring or for example a detachment of the bolt from the actuator, in which case moving the actuator to an inactive position will not cause the bolt to move accordingly. Especially this second drawback incurs serious danger in case of for example a fire as the emergency exit will in that case not open as expected by fleeing people.

### SUMMARY OF THE INVENTION

The present invention addresses one or more of the above drawbacks and provides a locking device comprising:
a lock comprising a bolt; and
a counter plate defining a slot for receiving said bolt and as such allowing locking an access point;
wherein said locking device comprises;
a housing;
an electrically powered actuator driving said bolt or counter plate between a locking position wherein said bolt is positioned in the slot of the counter plate and an unlocking position wherein said bolt is retracted from said slot in the counter plate;
a carriage movably mounted in the housing between an active position and an inactive position, such that in the active position with the bolt or counter plate in the locking position, said bolt is positioned in the slot of the counter plate, whereas in an inactive position of the carriage the bolt and counter plate can not engage with one another, irrespective of its position versus the actuator,
a spring provided in the housing and biasing said carriage to its active position;
a handle configured to drive said carriage by manpower against the force of said spring, from an active position to an inactive position.

Preferably, said handle is mounted on the housing by a pivot.

According to a preferred embodiment a lever is pivotably coupled to on the one hand, said carriage and, on the other hand, the handle for transferring motion on the lever to a motion of the carriage.

The locking device also preferably comprises a detector unit configured to determine whether the bolt is facing the slot in the counter plate.

According to a preferred embodiment, said detector unit is electronically coupled to a microprocessor configured to control the electrically driven actuator, said microprocessor configured to control said electrically drive actuator such that said bolt or counter plate is driven or maintained in an unlocking position in case the bolt is not facing the slot in the counter plate; and in that said bolt or counter plate is driven to a locking position when the bolt is facing the slot in the counter plate.

The locking device may comprise an electronic access controller electronically coupled to the microprocessor, whereby the microprocessor is configured to control the electrically driven actuator, said microprocessor configured to control said electrically drive actuator on basis of a signal provided by the electronic access controller.

Preferably, the locking device according to the present invention comprises a supercapacitor driving a microprocessor configured to control a motor for said electrically drive actuator, and optionally a detector unit configured to determine whether the bolt is facing the slot in the counter plate. Said supercapacitor providing power to the locking device in case of an external power interruption.

In accordance with a preferred embodiment, one of the lock or the counter plate is configured to be mounted on an outer surface of a door.

According to a preferred embodiment, the carriage comprises a handling point fixed in view of the carriage's housing, which handling point is configured to cooperate with said handle for driving the carriage, whereby said handling point travels along a pathway in view of the housing from a proximal point when said carriage is in the active position to a distal point when the carriage is in the inactive position. According to a preferred embodiment, a part of this pathway defined between the handling point and the distal point is void of any hardware such that the handling point can always be moved towards the distal point of the pathway, irrespective of the handle or any intermediate elements.

The carriage is preferably cylindrical or predominantly cylindrical.

### BRIEF DESCRIPTION OF THE APPENDED FIGURE

FIG. 1 schematically illustrates a lock part of a locking device of the present invention;

FIG. 2 shows an exploded view of the locking device of FIG. 1;

FIGS. 3a & 3b show a cross-section of the locking device of FIG. 1 in different positions;

FIG. 4 shows another cross-section of the locking device of FIG. 1 in yet another position;

FIGS. 5a & 5b show similar cross-sections as FIGS. 3a & 3b yet of another embodiment of a locking device according to the present invention;

FIG. 6 shows a cross-section of an other embodiment of the locking device of the present invention;

FIGS. 7a & 7b show similar cross-sections as FIGS. 3a & 3b yet of another embodiment of a locking device according to the present invention.

### DETAILED DESCRIPTION OF A PREFERRED EMBODIMENT OF THE INVENTION

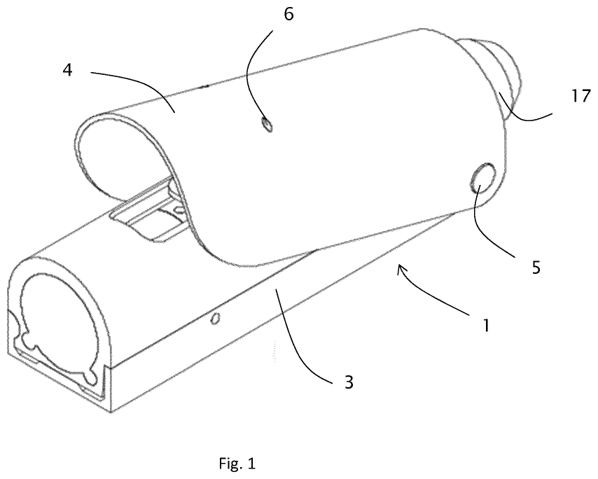

As illustrated in FIGS. 1 & 2, the locking device of the invention comprises a lock 1 that in this case is designed to be mounted on a surface of a door and a counter plate 2 (not shown in FIG. 1) designed to be mounted on a fixed frame of the door.

In this case, the lock comprises a housing 3 with a handle 4 attached to the exterior of the housing by means of an axis 5 extending parallel to the X-Y plane and that acts as a pivot. As shown by two punctures 6 in the handle, two protrusions are provided on a surface of the handle facing the housing. These protrusions are preferably provided at a distance of the axis 5 such as to create a moment arm 6 between the pivot and the abutment service.

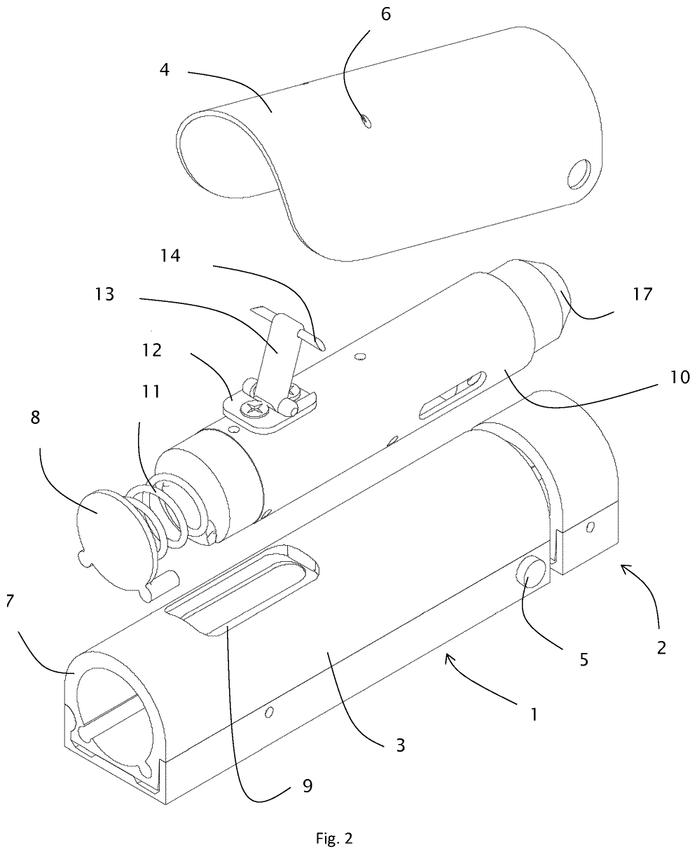

The housing in this case comprises a longitudinal side wall 7, for example tubular, that is open to one side and closed by an end wall 8 (FIG. 2) at on opposite side. In the longitudinal side wall an elongated slot 9 is provided.

Inside the housing 3 a carriage 10 is positioned such that is able to slide in a longitudinal direction of the housing, with a spring 11, in this case provided between the end wall 8 and the carriage 10, biasing the carriage to slide towards the open end of the housing.

The carriage 10 is in this case cylindrically shaped with on an outer surface thereof a protrusion 12 that is configured to slide in the elongated slot 9 of the housing. On said protrusion a lever 13 is pivotably mounted, whereby at the free end of the lever an axis 14 is provided that is configured to cooperate with the protrusions in the handle 4.

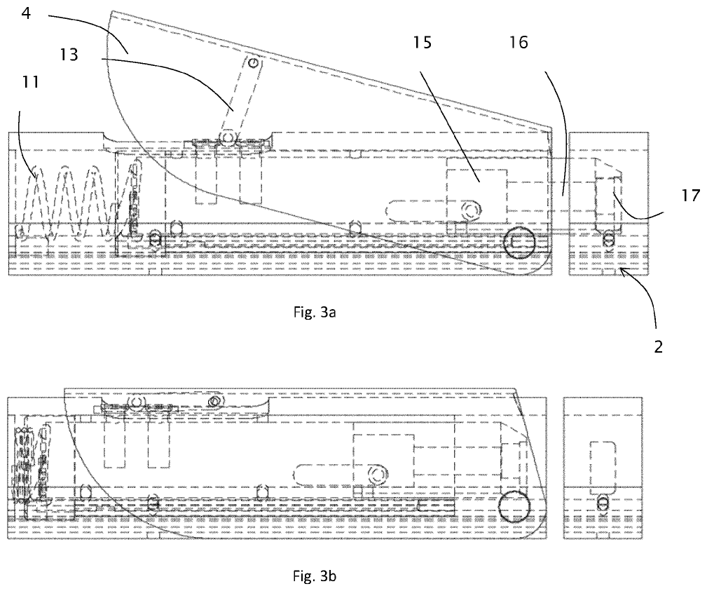

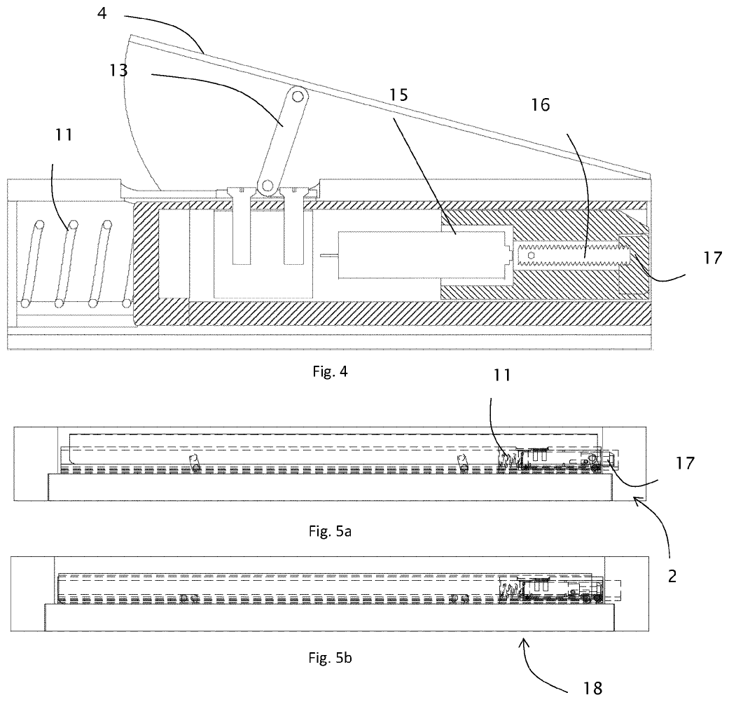

Inside the carriage, as shown in FIGS. 3a, 3b and 4, an electrically driven actuator 15 is provided comprising a motor driving a spindle 16 that at its free end is attached to a bolt 17. The electrically driven actuator may be powered by a battery or a power grid, whereas control of the motor can be provided by a microcontroller provided in the housing that is operated by a microchip in the housing or an external computer system.

Preferably means are provided on the actuator and the bolt for preventing rotation thereof in the carriage, such means could comprise a pen mounted on the slot and or the bolt, which pen is lodged in a aperture in the carriage sidewall; or by a non-cylindrical design of the actuator and/or bolt and/or inner room of the carriage.

As mentioned the locking device of the present invention is preferably made for controlling the access through a door and is preferably made to be mounted on an outer, visible surface of a concerned door, with the counter plate provided on a concerned fixed door frame.

In normal conditions, the carriage is in an active position, such that the actuator can drive the bolt into the slot of the counter plate. Control of the actuator for switching the bolt between the locking position and the unlocking position can be provided in multiple ways by means of a computer or by means of a control unit (eg. comprising a badge reader) provided internally in the housing or external thereof.

In case of an emergency such as a panicking crowd, the door can be opened irrespective of the position of the bolt versus the actuator by actuating-in this case pressing-the handle. Upon pressing down the handle, the lever 13 will force the carriage against the force of the spring 11 to an inactive, retracted position inside the housing. As a result, the actuator mounted in the carriage moves together with the spindle 16 and bolt 17 in a same direction towards the end wall 8 of the housing, until the bolt, irrespective of its position versus the actuator no longer can engage with the counter plate (FIG. 3b). In this position of the carriage, addressed as the inactive position, the door is open and people can be evacuated therethrough.

Once the handle is released, the spring will force the carriage back in its forward position against the shoulder portion and the bolt can again engage the counter plate when moved in a locking position by the actuator (FIG. 3a), this without the need for a technical intervention to reactivate the locking device. The movement of the carriage from an inactive position to an active position is limited by the dimension of the elongated slot 9 in the sidewall of the housing, wherein the protrusion 12 on the carriage moves.

Swift movement of the carriage from the active to the inactive position is in this case obtained by the moment arm between the pivot and the protrusions 6 on the handle, such that the force that is to be applied on the handle to move the carriage from the active to inactive position is minimised and a relative strong spring can be used to keep the actuator in the active position of the locking device to prevent accidental opening of the door.

It is preferred that the carriage or bolt comprises a detector unit (not shown) for detecting whether the bolt faces the slot of the counter plate. The detector unit is preferably electronically coupled to the microprocessor configured to control the electrically driven actuator. As such the actuator can be controlled on basis of its position versus the counter plate, whereby the locking device only shifts to a locking position when the bolt actually faces the slot in the counter plate.

FIGS. 5a and 5b, illustrate a push-bar 18 according to the invention. Such push-bar typically has a length that substantially corresponds to the width of a door. The push-bar 18 has the same built-up as the locking device described above.

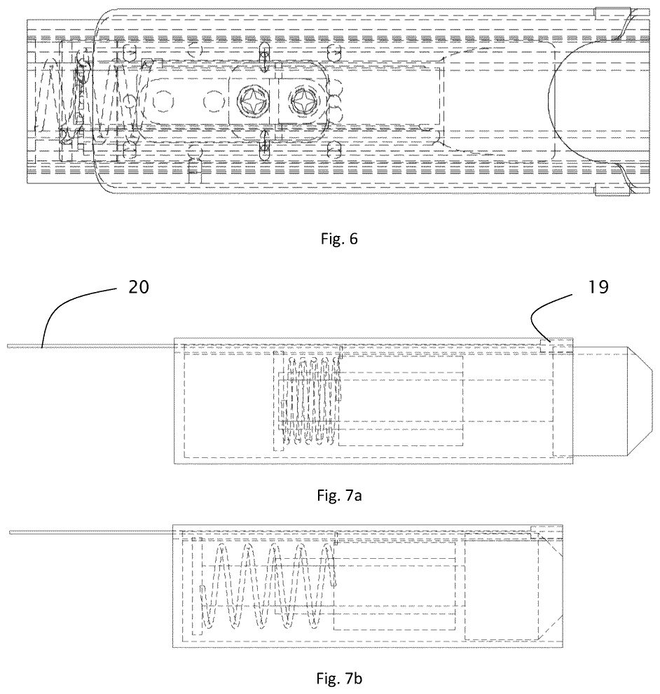

FIG. 6 shows an alternative embodiment of the current invention, wherein the bolt remains in an extracted position, but wherein the counter plate is provided in a carriage that is mounted in a housing as described above. Such embodiment is in fact very similar to the one described with reference to FIGS. 1 to 4, wherein the bolt is executed as a hollow tube (and thereby forms the counter plate) whereas the counter plate is executed as a pen (and thereby forms the bolt). Such setup can be advantageous when providing the actuator with energy from the power grid, as it allows mounting the housing (and actuator provided therein) on a fixed door frame.

FIGS. 7a & 7b show a locking device according to the present invention comprising a magnetic contact 19 powered by a powerline feeding 20 the electrically powered actuator. In this case the powerline is constantly powered, while the magnetic contact opens or closes the circuit, thereby switching the electrically powered actuator on or off. The magnetic contact is in this case closed by a magnetic counter plate (not shown) such that the electrically powered actuator is only provided with electrical power when the lock faces the counter plate (the door is closed).

This setup of the locking device ensures that the bolt is always retracted in the unlocking position when the door is either open or a general power cut occurs (eg in case of a fire alarm). As the bolt of the lock is always in an unlocking position when the door is open, the door can always be swung shut without the bolt hitting the side of the fixed door frame. This setup also ensures that in case of an alarm, the door can be easily opened as the bolt is retracted in an unlocking position.

It is also possible to decouple the actuator and the handle operated shifting carriage, eg. by providing the counter plate in a housing with movable carriage that can be operated by the handle against the force of the spring and a bolt operated by an electrically driven actuator or vice versa. In such case pressing the handle will shift the carriage to a position wherein no engagement between bolt and counter plate is possible (inactive position), whereas in situation wherein the handle is released, the bolt and counter plate can engage with one another to close the door by shifting the bolt or counter plate from an unlocking position to a locking position by means of the electrically driven actuator.

The lock device according to the present invention may comprise a supercapacitor, electrically coupled to the microprocessor, to the actuator and optionally to the detector unit. This actuator can be mounted in an electrical circuit for loading the supercapacitor when an external power source is present and for supplying energy to the microprocessor, to the actuator and optionally to the detector unit in case of an external power interruption. As such, the locking device can be controlled in both a ‘fail safe’ mode wherein the locking device opens in case of a power interruption (the supercapacitor in that case drives the actuator to open retract the bolt) or in a ‘fail secure’ mode wherein the locking device remains in a closed position in case of a power interruption (unless of course the handle is operated to move the carriage into its inactive position).

According to a preferred embodiment, the carriage is physically connected to the power line providing the locking device with power. This powerline preferably exits the carriage at its distal end, such that in case one desires moving the carriage from its active to inactive position, this can be achieved by pulling on the power line.

1. A locking device comprising:
a lock comprising a bolt; and
a counter plate defining a slot for receiving said bolt and as such allowing locking an access point;
wherein said locking device comprises;
a housing;
an electrically powered actuator driving said bolt or counter plate between a locking position wherein said bolt is positioned in the slot of the counter plate and an unlocking position wherein said bolt is retracted from said slot in the counter plate;
a carriage movably mounted in the housing between an active position and an inactive position, such that in the active position with said bolt or counter plate in the locking position, said bolt is positioned in the slot of the counter plate, whereas in the inactive position of the carriage, said bolt and counter plate cannot engage with one another, irrespective of position of the carriage versus the actuator,
a spring provided in the housing and biasing the carriage to its active position;
a handle configured to drive the carriage by manpower against the force of said spring, from the active position to the inactive position.

2. The locking device according to claim 1, wherein said handle is mounted on the housing by a pivot.

3. The locking device according to claim 1, comprising a lever pivotably coupled to on the one hand, the carriage and, on the other hand, the handle.

4. The locking device according to claim 1, comprising a detector unit configured to determine whether said bolt is facing the slot in the counter plate.

5. The locking device according to claim 1, wherein said detector unit is electronically coupled to a microprocessor configured to control the electrically powered actuator, said microprocessor configured to control said electrically powered actuator such that said bolt or counter plate is driven or maintained in the unlocking position in case the bolt is not facing the slot in the counter plate; and
in that said bolt or counter plate is driven to the locking position when said bolt is facing the slot in the counter plate.

6. The locking device according to claim 1, comprising an electronic access controller electronically coupled to said microprocessor, whereby said microprocessor is configured to control the electrically powered actuator, said microprocessor configured to control said electrically powered actuator on basis of a signal provided by the electronic access controller.

7. The locking device according to claim 1, said lock configured to be mounted on an outer surface of a door and said counter plate configured to be mounted on a fixed door frame.

8. The locking device according to claim 1, said counter plate configured to be mounted on an outer surface of a door and said lock configured to be mounted on a fixed door frame.
